(19) United States
(12) Patent Application Publication
(10) Pub. No.: US 2011/0294031 A1
(43) Pub. Date: Dec. 1, 2011

(54) COMPOSITE MEMBRANE AND FUEL CELL

(75) Inventors: Masashi Fujisawa, Kobe-shi (JP); Takashi Yasuo, Kobe-shi (JP)

(73) Assignee: SANYO ELECTRIC CO., LTD.

(21) Appl. No.: 13/149,150

(22) Filed: May 31, 2011

(30) Foreign Application Priority Data
May 31, 2010 (JP) 2010-125398
Mar. 25, 2011 (JP) 2011-068617

(51) Int. Cl. H01M 8/24

(52) U.S. Cl. 429/465

(57) ABSTRACT

Membrane electrode assemblies are disposed in openings provided in a substrate, respectively. Each membrane electrode assembly includes an electrolyte membrane, an anode catalyst layer, and a cathode catalyst layer. The substrate has an insulating region that insulates a conducting region used to connect an adjacent membrane electrode assembly in series, and an insulating region used to insulate the periphery of the membrane electrode assembly. The conducting region is provided between adjacent membrane electrode assemblies. The conducting region and the insulating region share the same material used for their base portions, and the electric conductivity increases continuously from the insulating region toward the conducting region.

This application is based upon and claims the benefit of priority from the prior Japanese Patent Applications No. 2010-125398, filed on May 31, 2010 and No. 2011-068617, filed on Mar. 25, 2011, the entire contents of which are incorporated herein by reference.

### BACKGROUND OF THE INVENTION

1. Field of the Invention

The present invention relates to a fuel cell. More particularly, the invention relates to a planar fuel cell system.

2. Description of the Related Art

A fuel cell is a device that generates electricity from hydrogen and oxygen so as to obtain highly efficient power generation. A principal feature of the fuel cell is its capacity for direct power generation which does not undergo a stage of thermal energy or kinetic energy as in the conventional power generation. This presents such advantages as high power generation efficiency despite the small scale setup, reduced emission of nitrogen compounds and the like, and environmental friendliness on account of minimal noise or vibration. In this manner, the fuel cells are capable of efficiently utilizing chemical energy in its fuel and, as such, environmentally friendly. Fuel cells are therefore expected as an energy supply system for the twenty-first century and have gained attention as a promising power generation system that can be used in a variety of applications including space applications, automobiles, mobile devices, and large and small scale power generation. Serious technical efforts are being made to develop practical fuel cells.

In particular, polymer electrolyte fuel cells feature lower operating temperature and higher output density than the other types of fuel cells. In recent years, therefore, the polymer electrolyte fuel cells have been emerging as a promising power source for mobile devices such as cell phones, notebook-size personal computers, PDAs, MP3 players, digital cameras, electronic dictionaries or electronic books. Well known as the polymer electrolyte fuel cells for mobile devices are planar fuel cells, which have a plurality of single cells arranged in a plane. As a conventional method for arranging a plurality of single cells in a plane, a base material (substrate) is used and a plurality of through-holes are provided in this base material which is a nonelectrolyte. And these through-holes are filled with electrolytes to fabricate planar fuel cells using a composite membrane. The use of the base material makes it possible to use an electrolyte whose proton conductivity is high but whose mechanical strength is weak. Also, the use of the base material reduces the electrolyte part as much as possible, thereby reducing the cost.

For fuel cells where multiple cells are arranged in a plane, it is difficult to electrically connect the cells in series as compared with those having a stack structure. To cope with this problem, a method is implemented where the connection wiring penetrates through a solid polymer membrane, but in this case there arises a problem of (1) contact failure in the connection wiring and (2) gas leak.

### SUMMARY OF THE INVENTION

The present invention has been made in view of the foregoing problems, and a purpose thereof is to provide a technology by which the connection reliability of interconnectors is improved wherein the interconnectors are used to electrically connect adjacent cells in a fuel cell where multiple cells are arranged in a plane.

One embodiment of the present invention relates to a composite membrane. The composite membrane includes: a substrate having a plurality of openings therein; and a plurality of membrane electrode assemblies, disposed in the plurality of openings, respectively, each membrane electrode assembly including (1) an electrolyte membrane containing an electrolyte membrane having ionomer, (2) an anode catalyst layer provided on one face of said electrolyte membrane, and (3) a cathode catalyst layer provided on the other face thereof, the substrate having (i) an insulating region used to insulate a periphery of the membrane electrode assembly and (ii) a conducting region used to electrically connect an anode catalyst layer of the adjacent membrane electrode assembly to the cathode catalyst layer provided on the other face thereof, wherein the electric conductivity of the substrate increases continuously from the insulating region toward the conducting region. That the electric conductivity of the substrate increases continuously includes not only a case where it increases along a continuous curve as shown in FIG. 5 but also a case where the electric conductivity becomes constant in a part of the region or a case where an intermediate region is provided between the insulating region and the conducting region.

By employing the above-described embodiment, the conducting regions used to connect adjacent membrane electrode assemblies in series with each other are formed by continuously varying the electric conductivity of the substrate. Thus the conducting region is not formed by a constituent member different from the substrate and therefore a space is less likely to be created in the conducting region. As a result, the connection reliability of the conducting regions used to connect adjacent membrane electrode assemblies in series with each other can be improved.

In the composite membrane of the above-described embodiment, a graphitization degree of the substrate may increase from the insulating region toward the conducting region. The substrate may further have a current-collecting region, provided in a surface layer portion of the substrate in contact with the anode catalyst layer or the cathode catalyst layer of at least one of the membrane electrode assemblies, the current-collecting region electrically connecting to the conducting region, wherein the electric conductivity of the substrate may increase continuously from the insulating region toward the current-collecting region. Also, there may be are a plurality of membrane electrode assemblies, disposed linearly and connected in series with each other, which belong to a first row, and there may be a plurality of membrane electrode assemblies, disposed linearly and connected in series with each other, which belong to a second row, the second row being disposed in parallel to the first row; one of the conducting regions may connect a first membrane electrode assembly, positioned at an end of the plurality of membrane electrode assemblies, belonging to the first row to a second membrane electrode assembly, positioned at an end of the plurality of membrane electrode assemblies and positioned counter to the first membrane electrode assembly, belonging to the second row in series with each other. The insulating region of the substrate may be formed of aromatic polymer graphitized by heat. Also, the aromatic polymer may be formed of a polyimide, and the conducting region of the substrate may be formed of a polyimide graphitized by heat.

Another embodiment of the present invention relates to a fuel cell. The fuel cell has the above-described composite membrane.

It is to be noted that any arbitrary combinations or rearrangement, as appropriate, of the aforementioned constituting elements and so forth are all effective as and encompassed by the embodiments of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is an exploded perspective view of a fuel cell according to an embodiment of the present invention;

FIG. 2 is a cross-sectional view taken along the line A-A′ of FIG. 1;

FIG. 3A is a planar view of a composite membrane as viewed from an anode side;

FIG. 3B is a planar view of a composite membrane as viewed from a cathode side;

FIG. 3C is a cross-sectional view taken along the line A-A′ of FIG. 3A;

FIG. 3D is a cross-sectional view taken along the line C-C′ of FIG. 3A;

FIG. 4A is a planar view of a composite membrane, omitting an anode catalyst layer, as viewed from an anode side;

FIG. 4B is a planar view of a composite membrane, omitting a cathode catalyst layer, as viewed from a cathode side;

FIG. 5 is a graph showing the electric conductivity of a conducting region and an insulating region of a substrate.

FIGS. 6A(i) to 6B(ii) are process diagrams showing a fabrication method of a composite membrane used for a fuel cell according to an embodiment;

FIGS. 7(i) and 7(ii) are process diagrams showing a fabrication method of a composite membrane used for a fuel cell according to an embodiment;

FIGS. 8A(i) to 8B(ii′) are process diagrams showing a fabrication method of a composite membrane used for a fuel cell according to an embodiment;

FIGS. 9A(i) to 9B(ii′) are process diagrams showing a fabrication method of a composite membrane used for a fuel cell according to an embodiment;

FIGS. 10A(i) to 10B(ii′) are process diagrams showing a fabrication method of a composite membrane used for a fuel cell according to an embodiment;

FIG. 11 is a process diagram showing a fabrication method of a composite membrane used for a fuel cell according to an embodiment;

FIGS. 12A and 12B are each a partially enlarged view showing a detailed structure and fabrication method of a conducting region;

FIG. 13 is a microscopic image of an insulating region and an conducting region formed by laser irradiation; and

FIG. 14 is a microscopic image of an insulating region and an conducting region formed by laser irradiation.

### DETAILED DESCRIPTION OF THE INVENTION

The invention will now be described by reference to the preferred embodiments. This does not intend to limit the scope of the present invention, but to exemplify the invention.

Hereinbelow, the embodiments will be described with reference to the accompanying drawings. Note that in all of the Figures the same reference numerals are given the same components and the description thereof is omitted as appropriate.

### First Embodiment

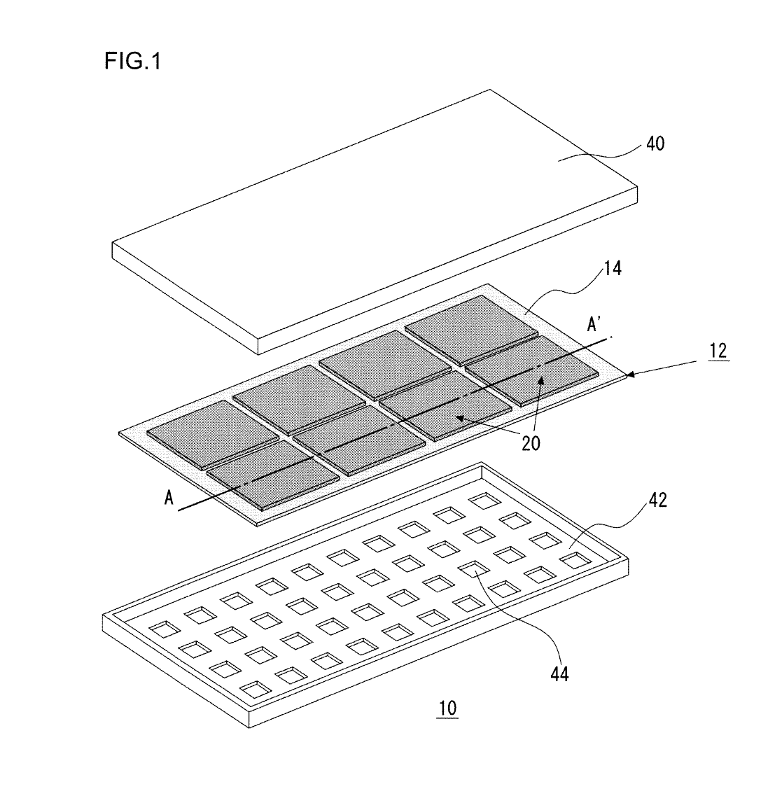

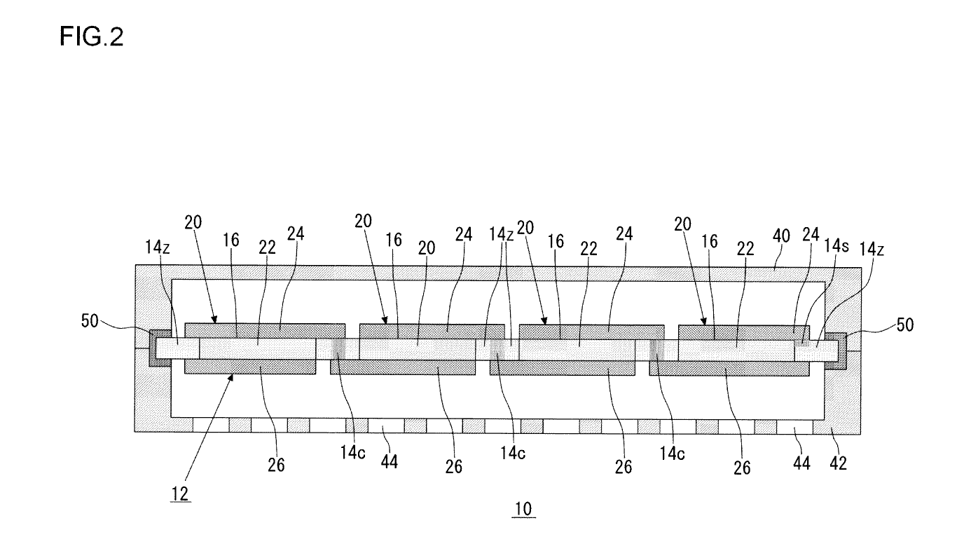

FIG. 1 is an exploded perspective view of a fuel cell 10 according to an embodiment of the present invention. FIG. 2 is a cross-sectional view thereof taken along the line A-A′ of FIG. 1. As shown in FIG. 1 and FIG. 2, the fuel cell 10 includes a composite membrane 12 into which membrane electrode assemblies (MEA, also called a catalyst coated membranes (CCM)) 20 are incorporated, an anode housing 40, and a cathode housing 42. A sealing members 50 (described later) is provided around the peripheral edge part of the composite membrane 12.

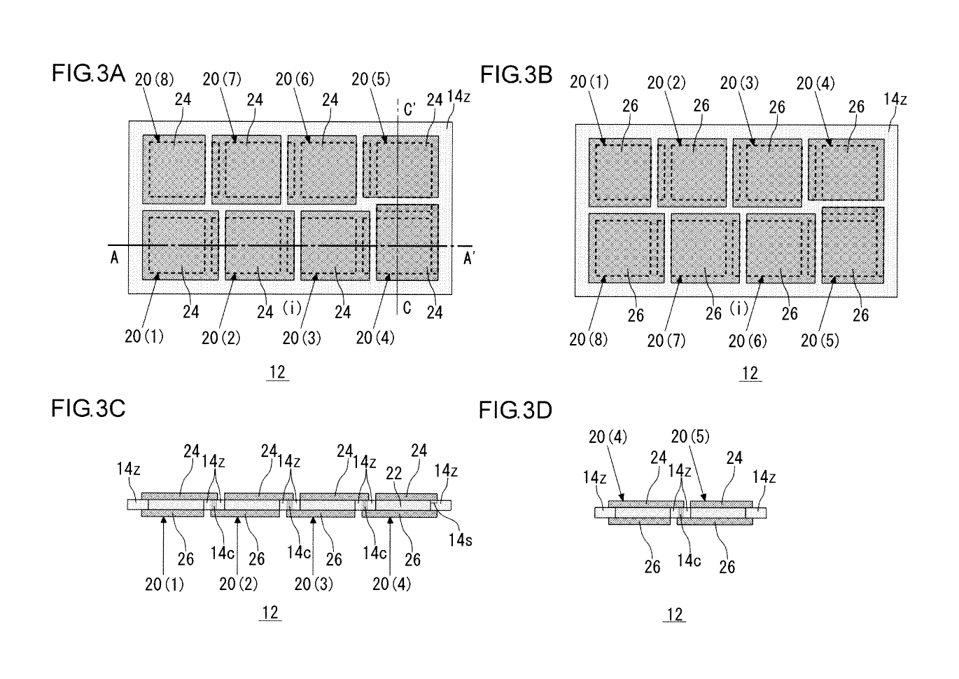

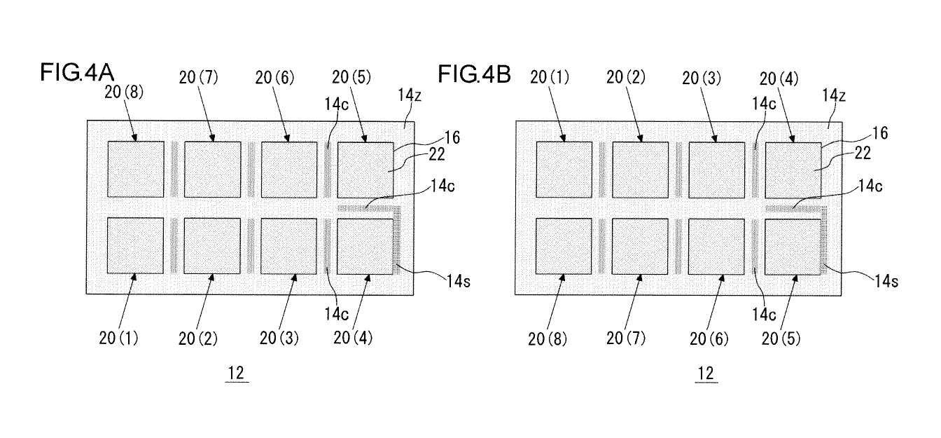

FIG. 3A is a planar view of the composite membrane 20 as viewed from an anode side. FIG. 3B is a planar view of the composite membrane 20 as viewed from a cathode side. FIG. 3C is a cross-sectional view thereof taken along the line A-A′ of FIG. 3A. FIG. 3D is a cross-sectional view thereof taken along the line C-C′ of FIG. 3A. FIG. 4A is a planar view of the composite membrane 12, omitting an anode catalyst layer, as viewed from an anode side. FIG. 4B is a planar view of the composite membrane 12, omitting a cathode catalyst layer, as viewed from a cathode side.

Referring to FIG. 3 and FIG. 4, a structure of the composite membrane 12 is described. The composite membrane 12 includes a substrate 14 and a plurality of MEAs 20. A plurality of openings 16 the number of which is equal to the number of MEAs 20 are provided in the substrate 14, and there are formed the MEAs 20 corresponding to the respective openings 16.

Each MEA 20 includes an electrolyte membrane 22, an anode catalyst layer 24 provided on one face of the electrolyte membrane 22, and a cathode catalyst layer 26 provided on the other face of the electrolyte membrane 22. The electrolyte membrane 22 is so provided as to fill in the openings 16 provided in the substrate 14. Hydrogen is supplied to the anode catalyst layer 24 as fuel gas. Air is supplied to the cathode catalyst layer 26 as oxidant. Each cell is structured by a pair of anode catalyst layer 22 and cathode catalyst layer 26 with the MEA 22 held between the anode catalyst layer 24 and the cathode catalyst layer 26. Each cell generates electric power through an electrochemical reaction between hydrogen and oxygen in the air.

As described above, in the fuel cell 10 according to the present embodiment, the respective pairs of the anode catalyst layers 24 and the cathode catalyst layers 26 constitute a plurality of MEAs 20 or cells formed in a planar arrangement. Note here that each opening may be enclosed by four sides or may be such that one side is open and it is enclosed by the three sides. The open side may be removed after the forming.

The electrolyte membrane 22, which may show excellent ion conductivity in a moist or humidified condition, functions as an ion-exchange membrane for the transfer of protons between the anode catalyst layer 24 and the cathode catalyst layer 26. The electrolyte membrane 202 is formed of a solid polymer material such as a fluorine-containing polymer or a nonfluorine polymer. The material that can be used for the electrolyte membrane 22 is, for instance, a sulfonic acid type perfluorocarbon polymer, a polysulfone resin, a perfluorocarbon polymer having a phosphonic acid group or a carboxylic acid group, or the like. An example of the sulfonic acid type perfluorocarbon polymer is a Nafion ionomer dispersion (made by DuPont: registered trademark) 112. Also, an example of the nonfluorine polymer is a sulfonated aromatic polyether ether ketone, polysulfone or the like.

The anode catalyst layer 24 and the cathode catalyst layer 26 are each provided with ion-exchange material and catalyst particles or carbon particles as the case may be.

The ion-exchange material provided in the anode catalyst layer 24 and the cathode catalyst layer 26 may be used to promote adhesion between the catalyst particles and the electrolyte membrane 22. This ion-exchange material may also play a role of transferring protons between the catalyst particles and the electrolyte membrane 22. The ion-exchange material may be formed of a polymer material similar to that of the electrolyte membrane 22. A catalyst metal may be a single element or an alloy of two or more elements selected from among Sc, Y, Ti, Zr, V, Nb, Fe, Co, Ni, Ru, Rh, Pd, Pt, Os, Ir, lanthanide series element, and actinide series element. Acetylene black, ketjen black, carbon nanotube or the like may be used as the carbon particle when a catalyst is to be supported.

In the present embodiment, the number of MEAs 20 is equal to eight pairs of MEAs 20 which are an MEA 20(1) to an MEA 20(8). Of these eight pairs of MEAs 20(1) to 20(8), the MEA 20(1) to the MEA 20(4) are arranged along a longitudinal direction of the substrate 14 in a row, and in parallel with these MEAs 20(1) to 20(4), the MEA 20(5) to the MEA 20(8) are arranged in a row in the reverse order of how the MEAs 20(1) to 20(4) are arranged.

Each substrate 14 has insulating regions 14z and conducting regions 14c. The insulating region 14z is a region used to insulate the periphery of an MEA 20. Provision of the insulating region 14z prevents adjacent MEAs 20 from being short-circuited with each other. The conducting region 14c is a region used to electrically connect an anode catalyst layer 24 of one of the adjacent MEAs 20 to a cathode catalyst layer 26 of the other thereof, and the conducting region 14 is a so-called interconnector. More specifically, the conducting region 14c is provided as a region that penetrates the substrate 14 between the adjacent MEAs 20 along a side of the electrolyte membrane 22, and is so provided as to be insulated from the adjacent electrolyte membranes 22 by the insulating regions 14z.

The MEA 20(1) to the MEA 20 (4) arranged side by side in a row are connected in series by each conducting region 14c provided between adjacent MEAs 20. Similarly, The MEA 20(5) to the MEA 20 (8) arranged side by side in a row are connected in series by each conducting region 14c provided between adjacent MEAs 20. Also, a conducting region 14c is provided between the MEA 20(4) and the MEA 20(5) (See FIG. 3D), so that the MEA 20(4) and the MEA 20(5) are connected in series with each other by this conducting region 14c. In this manner, the MEA 20(1) to the MEA 20(8) are connected in series by each conducting region 14c provided between adjacent MEAs 20.

As shown in FIG. 3A, the orientations of the MEAs 20 connected in series by the conducting regions 14c are such that the orientation of the MEA 20(4) and MEA 20(5) are shifted by 90 degrees relative to the orientation of the MEA 20(1) to the MEA 20 (4) and such that the orientation of the MEA 20(5) to the MEA 20(8) is further shifted by 90 degrees relative to the orientation of the MEA 20(4) and the MEA 20(5). In other words, a conducting path that connects the MEAs 20 comprising the MEA 20(1) to the MEA 20(8) is such that it is of U-shape where the conducting path is folded back at the MEA 20(4) and the MEA 20 (5). The connection mode achievable in the present embodiment is not only the arrangement where the MEAs 20 are linearly connected in series but also a connection according to any other arbitrary form. Thus, the size of the fuel cell can be reduced and the fuel cell can be designed with an increased degree of freedom in shape.

The substrate 14 according to the present embodiment also has a current collecting region 14s. The current collecting region 14s is a region used to enhance the current collecting property of a catalyst layer, and is provided on a surface layer of the substrate 14. More specifically, the current collecting region 14s is so provided as to be in contact with the anode catalyst layer 24 of the MEA 20(4) at an end region of the substrate 14 along the longitudinal direction thereof; this current collecting region 14s connects to the conducting region 14c provided between the MEA 20(4) and the MEA 20(5).

Also, the current collecting region 14s is so provided as to be in contact with the cathode catalyst layer 24 of the MEA 20(5) at an end region of the substrate 14 along the longitudinal direction thereof; this current collecting region 14s connects to the conducting region 14c provided between the MEA 20(4) and the MEA 20(5).

The insulating region 14z, the conducting region 14c and the current collecting region 14s share the same material used for their base portions, and these three regions whose functions differ from one another are formed by reforming the base material and varying the conductivity. Thus, no physical boundaries exists between the insulating region 14z and the conductive region 14c and between the insulating region 14z and the current collecting region 14s. Hence, the insulating region 14z, the conducting region 14c and the current collecting region 14s are each formed integrally with the substrate 14.

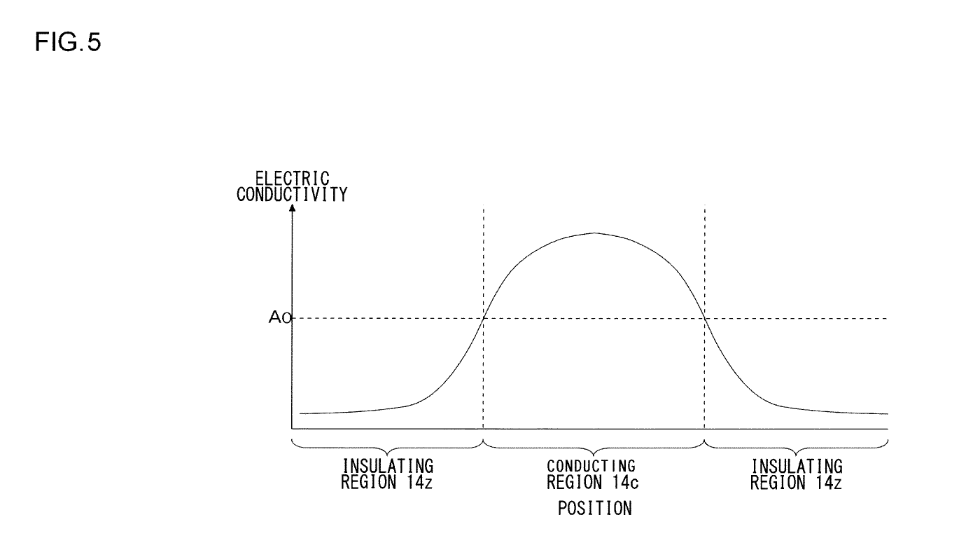

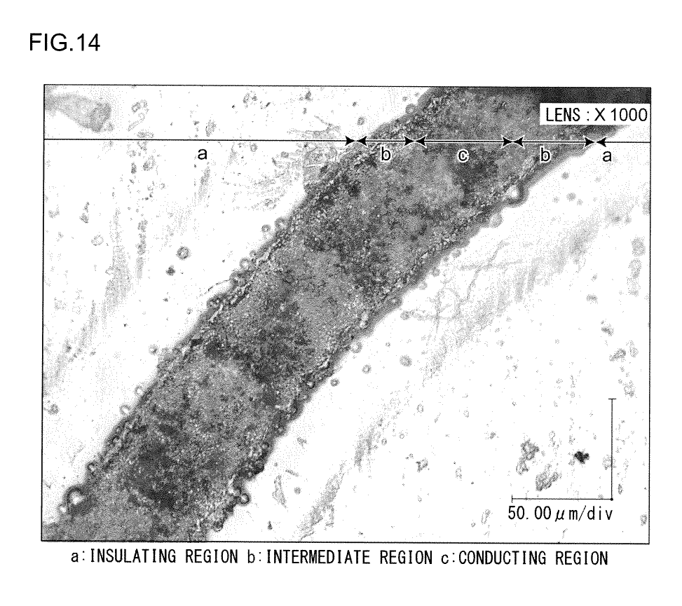

FIG. 5 is a graph showing the electric conductivity of the conducting region 14c and the insulating region 14z of the substrate 14. As shown in FIG. 14, the electric conductivity continuously increases from the insulating region 14z to the conducting region 14c. A region whose electric conductivity is at or above the electric conductivity A₀ which is a reference value corresponds to the conducting region 14c, whereas a region whose electric conductivity is below A₀ is the insulating region 14z. The electric conductivity is positively correlated with the degree of graphitization of the substrate 14. Thus the higher the degree of graphitization of the substrate 14 is, the higher the electric conductivity becomes. Hence, the electric conductivity representing the vertical axis of FIG. 5 may be replaced by the degree of graphitization. The degree of graphitization of the substrate 14 may be measured using the Raman spectrometric method, for instance.

The relation of the electric conductivity between the current collecting region 14s and the insulating region of the substrate 14 is similar to that of the graph shown in FIG. 5. That is, the electric conductivity continuously increases from the insulating region 14z to the conducting region 14s. A material used for the substrate 14 may be an aromatic polymer graphitized when heated, for instance. The aromatic polymer is structured such that a graphite microcrystal, where hexagonal net planes of carbon atoms are stacked when heated, is more likely to be formed, grown and arranged. The aromatic polymer used here may be polyimide, for instance. In this case, the insulating region 14z is formed of an insulating polyimide, whereas the conducting region 14c and the current collecting region 14s are formed by enhancing the degree of graphitization of polyimide.

The above-described composite membrane 12 is housed within a casing comprised of the anode housing 40 and the cathode housing 42. The anode housing 40 constitutes a fuel storage 37 for storing fuel. A fuel supply port (not shown) is formed in the anode housing 40, so that the fuel can be supplied as needed from a fuel cartridge or the like.

On the other hand, the cathode housing 42 is provided with air inlets 44 for feeding air from outside.

The anode housing 40 and the cathode housing 42 may be fastened to each other by fasteners (not shown), such as bolts and nuts, via sealing members 50 provided along a peripheral edge part of the composite membrane 12. The fasteners giving pressure to the sealing members 50 may improve the sealing performance of the sealing member 50.

In the fuel cell 10 according to the present embodiment, the interconnectors used to connect the adjacent MEAs 20 in series with each other are formed by reforming a material constituting the substrate 14 and continuously varying the electric conductivity. Thus, the interconnectors are not formed of a material different from that constituting the substrate 14 and therefore a space is less likely to be created in the interconnectors. As a result, the connection reliability of the interconnectors used to connect the adjacent MEAs 20 in series with each other can be improved. Also, cross leak in the interconnectors can be prevented.

Also, the current collecting region 14s is provided along a side which is different from the side of the MEA 20 provided with the conducting region 14c, so that the current collecting property of the MEAs 20 can be enhanced. Similar to the conducting regions 14c, the current collecting region 14s is formed by reforming the material constituting the substrate 14 and continuously varying the electric conductivity. Thus, a space is less likely to be created in the current collecting region 14s. As a result, the connection reliability of the current collecting region 14s can be improved.

### Method for Fabricating a Composite Membrane

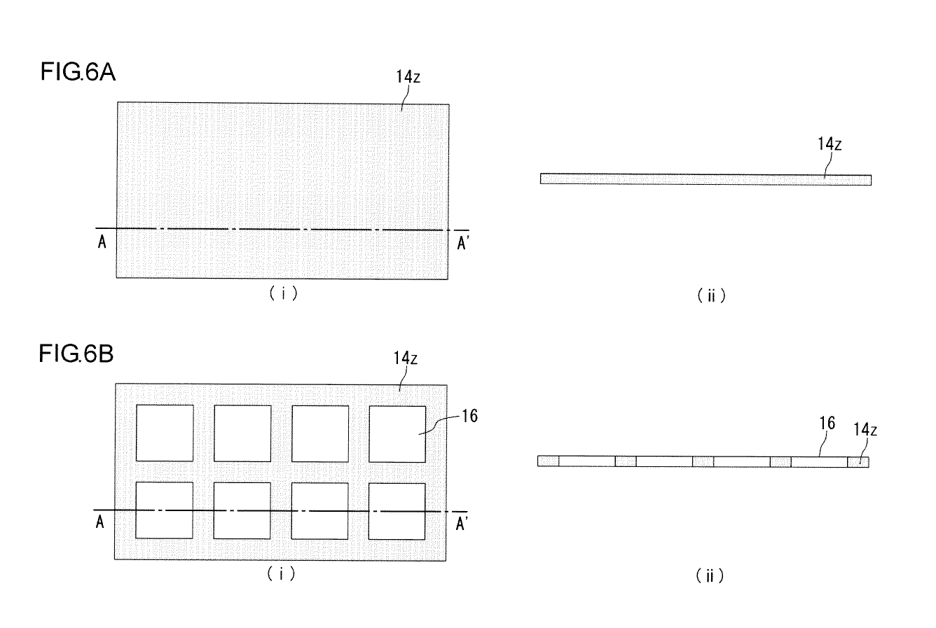

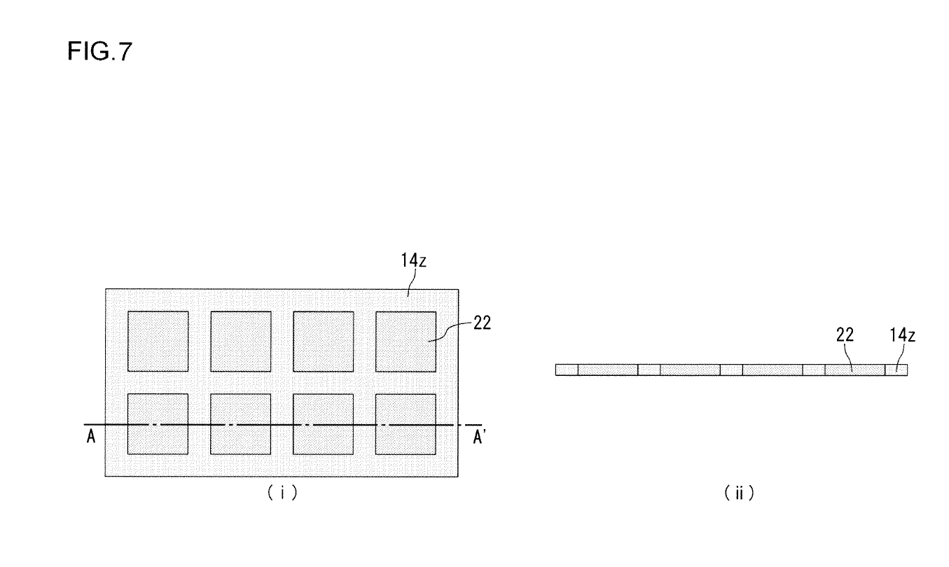

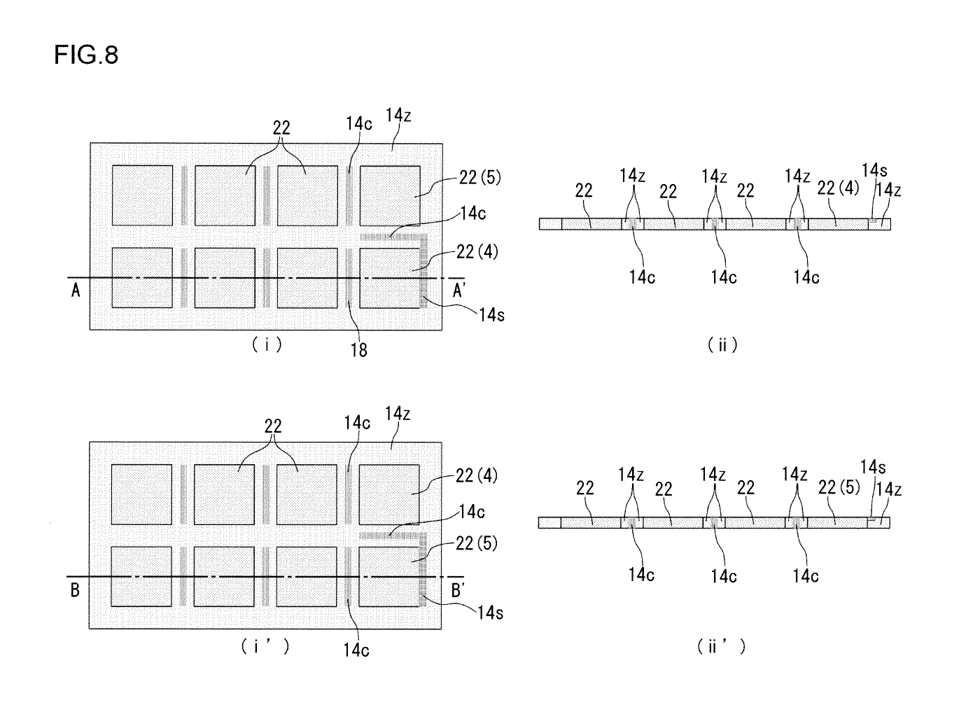

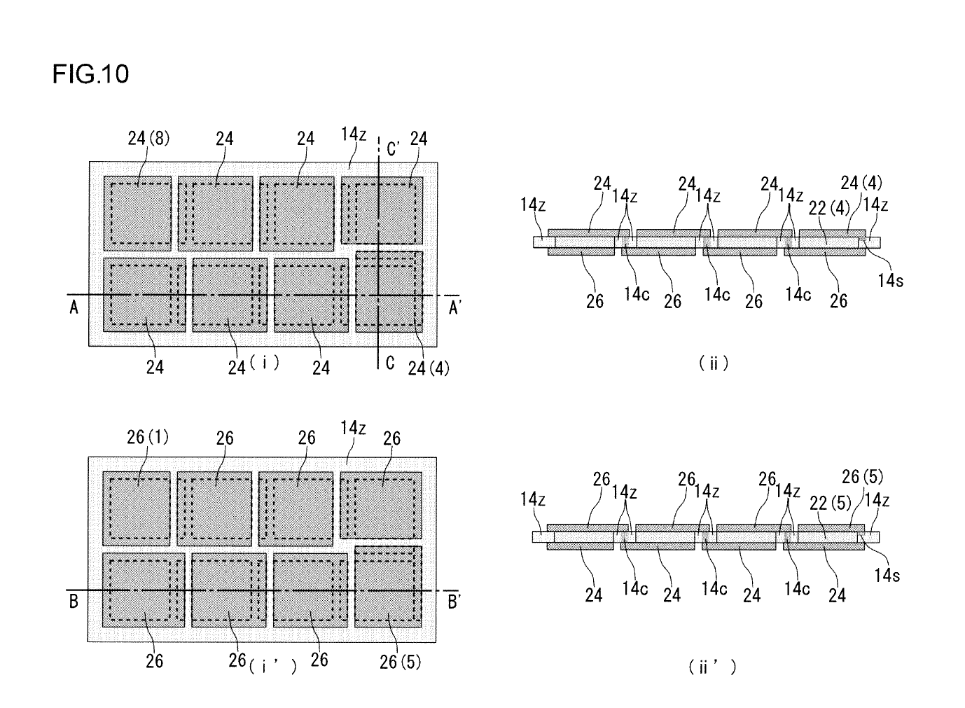

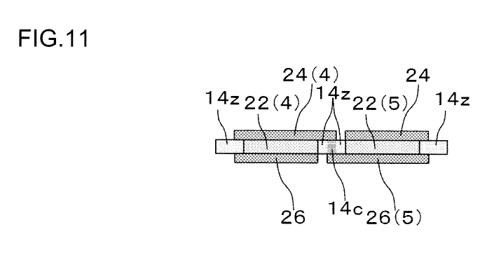

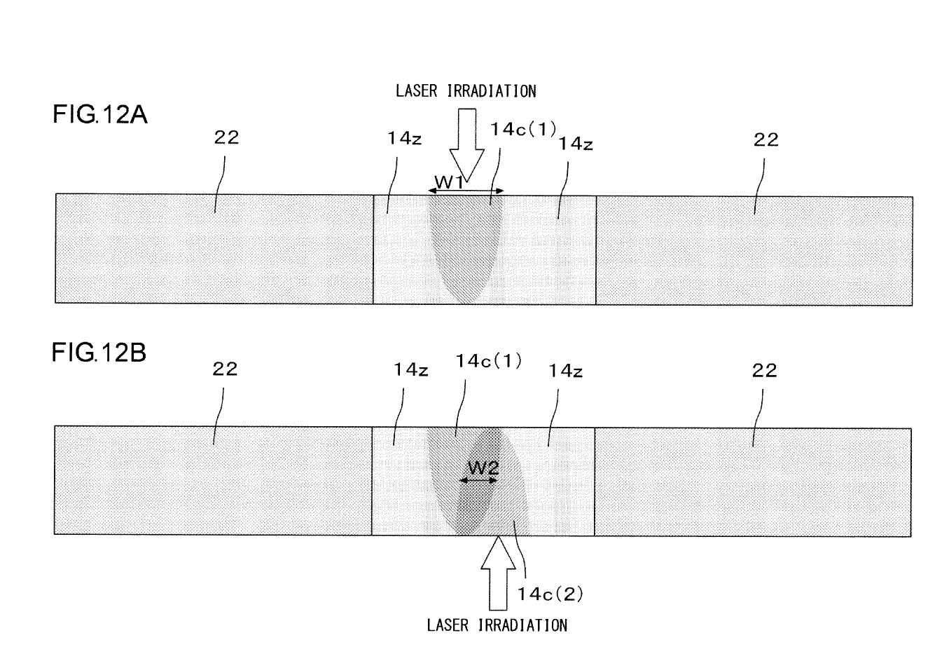

A method for fabricating a composite membrane 12 used for a fuel cell according to an embodiment will now be described with reference to FIG. 6A(i) to FIG. 12B. FIG. 6A(i) to FIG. 11 are process diagrams showing a method for manufacturing the composite membrane 12 according to the present embodiment. In FIG. 6A(i) to FIG. 7(ii), diagrams on the left (i) show plan views whereas those on the right (ii) show cross-sectional views taken along the line A-A′ of the respective plan views. In FIG. 8(i) to FIG. 10(ii′), diagrams on the left (i) and (i′) show plan views on an anode side, respectively, whereas those on the right (ii) and (ii′) show a cross-sectional view taken along the line A-A′ of the plan view and a cross sectional view taken along the line B-B′ thereof, respectively. FIG. 11 is a cross-sectional view taken along the line C-C′ of the plan view (i) of FIG. 10.

As shown in FIG. 6A, a substrate 14 formed such that polyimide is cast into a sheet-like shape is first prepared. The thickness of the substrate 14 is about 20 to about 150 μm. At this stage, the entire substrate 14 is an insulating region 14z.

Then, as shown in FIG. 6B, a plurality of openings 16 are provided in the substrate 14. The forming regions of the openings 16 corresponds to forming regions of electrolyte membrane, described later. The interval between the adjacent openings 16 along the longitudinal direction of the substrate 14 is about 800 μm, for instance. The openings 16 may be formed by a laser processing using infrared laser, visible-light laser or ultraviolet laser, a punching method using a metallic mold, or the like.

Then, as shown in FIGS. 7(i) and 7(ii), an electrolyte membranes 22 are formed in the openings 16 (see FIG. 6B) provided in the substrate 14. More specifically, the openings 16 are filled with Nafion dispersion solution and then the solvent is evaporated to form the electrolyte membranes 22. This method proves effective when the openings 16 are in microscale. Also, the electrolyte membranes 22 molded and formed beforehand in accordance with the size of the openings 16 may be fit into the openings 16. In such a case, it is preferable that the Nafion dispersion solution be poured into the interface between the substrate 14 and the electrolyte membrane 22 after the electrolyte membranes 22 has been fit into the openings 16. Since the Nafion dispersion solution functions as an adhesive here, the adhesion between the substrate 14 and the electrolyte membrane 22 can be enhanced.

Then, as shown in FIGS. 8(i) to 8(ii′), conducting regions 14c, which become interconnectors, are formed between the adjacent electrolyte membranes 22 in the longitudinal direction of the substrate 14. The conducting regions 14c are provided along the sides disposed counter to the adjacent electrolyte membranes 22 and, at this stage, the conducting regions 14c are spaced apart from any of the adjacent electrolyte membranes 22. Note that, at one end region of the substrate 14 along the longitudinal direction, a conducting region 14c is also formed between the adjacent electrolyte membrane 22(4) and 22(5) positioned vertically in FIGS. 8(i) and 8(ii′) (namely, in the lateral direction of the substrate 14).

As shown in FIGS. 8(i) and 8(ii), formed is a current collecting region 14s which extends along a side of the electrolyte membrane 22(4) on an anode side of the substrate 14 and connects to the conducting region 14c the other end of which is provided between the electrolyte membrane 22(4) and the electrolyte membrane 22(5). As shown in FIG. 8(i′) and 8(ii′), formed is a current collecting region 14s which extends along a side of the electrolyte membrane 22(5) on a cathode side of the substrate 14 and connects to the conducting region 14c the other end of which is provided between the electrolyte membrane 22(4) and the electrolyte membrane 22(5).

FIGS. 12A and 12B are each a partially enlarged view showing a detailed structure and fabrication method of the conducting region 14c. As shown in FIG. 12A, laser is irradiated toward a predetermined region of the insulating region 14z from one surface of the substrate 14, and then a conducting region 14c(1) is formed by graphitizing polyimide. At this time, the laser irradiation region is a region closer to one of the adjacent electrolyte membranes 22. The irradiation width W1 of laser bean is about 400 μm, for instance.

Then, as shown in FIG. 12B, laser is irradiated toward a predetermined region of the insulating region 14z from the other surface of the substrate 14, and then a conducting region 14c(2) is formed by graphitizing polyimide. At this time, the laser irradiation region is a region, closer to the other one of the adjacent electrolyte membranes 22, where the conducting region 14c(2) overlaps with the conducting region 14c(1). The width W2 of the region where the conducting region 14c(1) formed by the laser irradiation from one face of the substrate 14 and the conducting region 14c(2) formed by the laser irradiation from the other face thereof are overlapped with each other is about 200 μm, for instance.

By employing the above-described structure and method, the conducting region 14c can be reliably formed in a simplified manner even under the conditions where the irradiation of laser from one surface of the substrate does not result in the formation of the conducting region 14c that penetrates from one face of the substrate to the other surface thereof.

Similar to the conducting region 14c, the current collecting region 14s can be formed by irradiating the laser toward a predetermined region of the insulating region 14z. When the current collecting region 14s is to be formed, laser is irradiated to the surface layer of the anode-side insulating region 14z or the surface layer of the cathode-side insulating region 14z. In this case, the output of laser to be irradiated needs to be restricted as compared with the case of the formation of the conducting region 14c so that the current colleting region 14s does not penetrate the substrate 14.

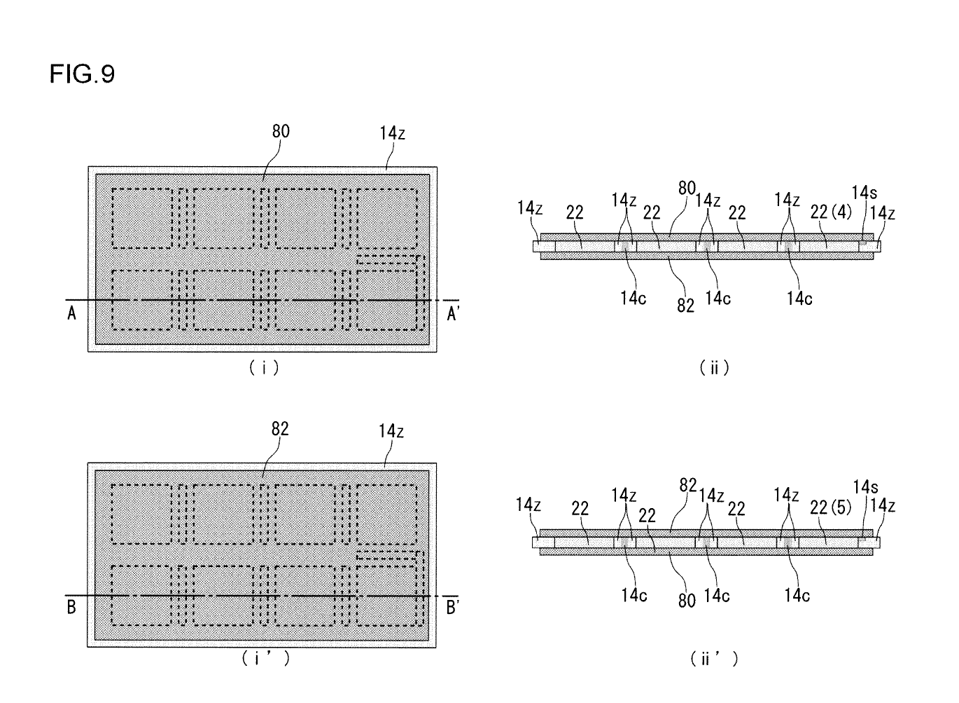

Then, as shown in FIGS. 9(i) and 9(ii), at the anode side of the substrate 14, a catalyst layer 80 is formed along the longitudinal direction of the substrate 14 in such a manner as to lie across a plurality of electrolyte membranes 22. More specifically, a catalyst slurry is adjusted by sufficiently stirring the water of 10 g, Nafion dispersion solution of 5 g, platinum black or platinum-supporting carbon of 5 g and 1-propanol of 5 g. And the catalyst layer 80 is formed by spray-coating this catalyst slurry. Similarly, as shown in FIGS. 9(i′) and 9(ii′), at the cathode side of the substrate 14, a catalyst layer 82 is formed along the longitudinal direction of the substrate 14 in such a manner as to lie across the plurality of electrolyte membranes 22. More specifically, the catalyst layer 82 is formed by spray-coating the aforementioned catalyst slurry.

Then, as shown in FIGS. 10(i) and 10(ii) and FIG. 11, a predetermined region of the catalyst layer 80 provided at the anode side of the substrate 14 is partially removed using laser beams such as excimer laser. Thereby, the catalyst layer 80 is segmentalized, so that anode catalyst layers 24 covering one electrolyte membrane 22 are formed. The anode catalyst layers 24 (except for the anode catalyst layer 24(8)) covering the electrolyte membrane 22 are so formed as to extend on the conducting region 14c provided near one side of each electrolyte membrane 22. Also, the anode catalyst layer 24(4) is so formed as to extend on the current collecting region 14s provided along one side of the electrolyte membrane 22(4).

Then, as shown in FIGS. 10(i′) and 10(ii′) and FIG. 11, a predetermined region of the catalyst layer 82 provided at the cathode side of the substrate 14 is partially removed using laser beams such as excimer laser. Thereby, the catalyst layer 82 is segmentalized, so that cathode catalyst layers 26 covering one electrolyte membrane 22 are formed. The cathode catalyst layers 26 (except for the cathode catalyst layer 26(1)) covering the electrolyte membrane 22 are so formed as to extend on the conducting region 14c provided near one side of each electrolyte membrane 22. Also, the cathode catalyst layer 26(5) is so formed as to extend on the current collecting region 14s provided along one side of the electrolyte membrane 22(5).

YAG third harmonic laser, YVO₄ fourth harmonic green laser or the like whose oscillation wavelength is greater than or equal to 180 nm and less than or equal to 550 nm may be used as laser for the removal of the catalyst layer, in place of the excimer laser. The output level of laser is preferably such that the predetermined regions of the catalyst layers to be irradiated with the laser can be completely removed thereby. And it is also preferable that the output level of laser is adjusted as appropriate in accordance with the material used for and/or thickness of the catalyst layer.

The composite membrane 12, into which the MEAs 20 are incorporated, according to the present embodiment are manufactured through the above-described processes. Though both the anode and the cathode are subjected to the similar process in each process of the above-described manufacturing processes and then a subsequent process is performed, the anode may be subjected to a series of processes and then the cathode may be subjected to a series of processes, for example.

### Laser Irradiation Experiment 1

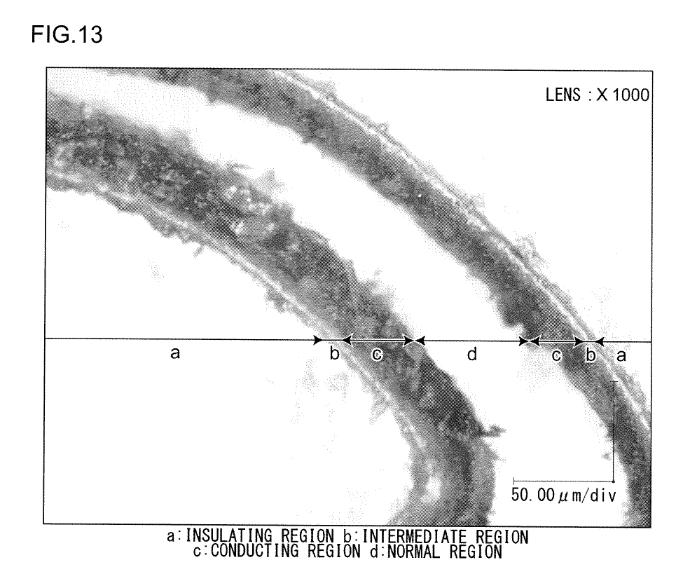

A polyimide film having the thickness of 25 μm is prepared and one surface of the polyimide film is irradiated with CO₂ laser by varying the intensity of CO₂ laser (maximum output: 75 W, wavelength: 9.3 μm) and the scanning speed thereof. A result of laser irradiation is shown in Table 1. “◯” (circle) in Table 1 indicates that the film is carbonized (i.e., the color changes to black) starting from the face irradiated with laser up to the back side and that no through-holes is formed in the polyimide film. “Δ” (triangle) in Table 1 indicates that the film is carbonized from the face irradiated with laser up to the back side but the through-holes are formed in the polyimide film. “x” in Table 1 indicates that only the face irradiated with laser is carbonized (i.e., the color changes to black). “-” in Table 1 indicates that the laser irradiation experiment is not conducted. As shown in Table 1, it is verified that when one surface of the polyimide film is irradiated with CO₂ laser, the film can be carbonized, without forming the through-holes, from the face irradiated with laser up to the back side by varying the intensity of CO₂ laser and the scanning speed thereof. Also, as shown in FIG. 13 and FIG. 14, the surface of the polyimide film irradiated with laser is observed using a microscope and the results indicate that the color of the material gradually changes from a graphite (black) part, which is a conducting region, by way of an intermediate color (gray) portion, which is an intermediate region. And it is estimated that the electric conductivity of the substrate gradually increase from the insulating region to the conducting region of the substrate (See FIG. 13 and FIG. 14).

TABLE 1

| Laser | Scanning speed (mm/sec.) | | | | |
|---|---|---|---|---|---|
| intensity | 300 | 500 | 1000 | 1500 | 2000 |
| 100 | — | Δ | Δ | Δ | x |
| 75 | — | Δ | Δ | Δ | x |
| 50 | — | Δ | ∘ | x | x |
| 25 | — | ∘ | x | x | x |
| 15 | ∘ | — | — | — | — |
| 10 | — | x | x | x | x |

### Laser Irradiation Experiment 1

A polyimide film having the thickness of 25 μm is prepared and one surface of the polyimide film is irradiated with CO₂ laser by CO₂ laser (output: 11.3 W, wavelength: 9.3 μm) at the scanning speed 300 mm/sec. The measured resistance value of a portion (0.9 mm×0.1 mm), in a penetrating direction, which is irradiated with the laser was 20Ω. In this case, the volume resistivity is [20(Ω)×0.09 (cm)×0.01 (cm)÷0.0025 (cm)]=7.2Ω·cm. Also, the measured resistance value of carbon paper in the penetrating direction was 5Ω. The carbon paper used here was TGP-H-060 made by Toray (the thickness: 0.2 mm, the size: 5 mm×5 mm). In this case, the volume resistivity is [5(Ω)×0.5 (cm)×0.5 (cm)÷0.02 (cm)]=62.5Ω·cm. From the above results, the volume resistivity in the case when the conducting region is formed with the polyimide film irradiated with laser is lower by a factor of 8.7 than that of the carbon paper. This verifies that the conducting region formed with the polyimide film irradiated with laser is sufficiently at practical level.

The present invention is not limited to the above-described embodiments only, and it is understood by those skilled in the art that various modifications such as changes in design may be made based on their knowledge and the embodiments added with such modifications are also within the scope of the present invention.

What is claimed is:

1. A composite membrane, comprising:
a substrate having a plurality of openings therein; and
a plurality of membrane electrode assemblies, disposed in the plurality of openings, respectively, each membrane electrode assembly including (1) an electrolyte membrane containing an electrolyte membrane having ionomer, (2) an anode catalyst layer provided on one face of said electrolyte membrane, and (3) a cathode catalyst layer provided on the other face thereof,
said substrate having (i) an insulating region used to insulate a periphery of said membrane electrode assembly and (ii) a conducting region used to electrically connect an anode catalyst layer provided on the one face of said adjacent membrane electrode assembly to the cathode catalyst layer provided on the other face thereof,
wherein the electric conductivity of said substrate increases continuously from the insulating region toward the conducting region.

2. A composite membrane according to claim 1, wherein a graphitization degree of said substrate increases from the insulating region toward the conducting region.

3. A composite membrane according to claim 1, said substrate further having a current-collecting region, provided in a surface layer portion of said substrate in contact with the anode catalyst layer or the cathode catalyst layer of at least one of said membrane electrode assemblies, said current-collecting region electrically connecting to the conducting region,
wherein the electric conductivity of said substrate increases continuously from the insulating region toward the current-collecting region.

4. A composite membrane according to claim 2, said substrate further having a current-collecting region, provided in a surface layer portion of said substrate in contact with the anode catalyst layer or the cathode catalyst layer of at least one of said membrane electrode assemblies, said current-collecting region electrically connecting to the conducting region,
wherein the electric conductivity of said substrate increases continuously from the insulating region toward the current-collecting region.

5. A composite membrane according to claim 1, wherein there are a plurality of membrane electrode assemblies, disposed linearly and connected in series with each other, which belong to a first row, and
there are a plurality of membrane electrode assemblies, disposed linearly and connected in series with each other, which belong to a second row, the second row being disposed in parallel with the first row, and
wherein one of the conducting regions connects a first membrane electrode assembly, positioned at an end of the plurality of membrane electrode assemblies, belonging to the first row to a second membrane electrode assembly, positioned at an end of the plurality of membrane electrode assemblies and positioned counter to the first membrane electrode assembly, belonging to the second row in series with each other.

6. A composite membrane according to claim 2, wherein there are a plurality of membrane electrode assemblies, disposed linearly and connected in series with each other, which belong to a first row, and
there are a plurality of membrane electrode assemblies, disposed linearly and connected in series with each other, which belong to a second row, the second row being disposed in parallel with the first row, and
wherein one of the conducting regions connects a first membrane electrode assembly, positioned at an end of the plurality of membrane electrode assemblies, belonging to the first row to a second membrane electrode assembly, positioned at an end of the plurality of membrane electrode assemblies and positioned counter to the first membrane electrode assembly, belonging to the second row in series with each other.

7. A composite membrane according to claim 3, wherein there are a plurality of membrane electrode assemblies, disposed linearly and connected in series with each other, which belong to a first row, and
there are a plurality of membrane electrode assemblies, disposed linearly and connected in series with each other, which belong to a second row, the second row being disposed in parallel with the first row, and
wherein one of the conducting regions connects a first membrane electrode assembly, positioned at an end of the plurality of membrane electrode assemblies, belonging to the first row to a second membrane electrode assembly, positioned at an end of the plurality of membrane electrode assemblies and positioned counter to the first membrane electrode assembly, belonging to the second row in series with each other.

8. A composite membrane according to claim 1, wherein the insulating region of said substrate is formed of aromatic polymer graphitized by heat.

9. A composite membrane according to claim 2, wherein the insulating region of said substrate is formed of aromatic polymer graphitized by heat.

10. A composite membrane according to claim 3, wherein the insulating region of said substrate is formed of aromatic polymer graphitized by heat.

11. A composite membrane according to claim 8, wherein the aromatic polymer is a polyimide.

12. A composite membrane according to claim 9, wherein the aromatic polymer is a polyimide.

13. A composite membrane according to claim 10, wherein the aromatic polymer is a polyimide.

14. A fuel cell having a composite membrane according to claim 1.

15. A fuel cell having a composite membrane according to claim 2.

16. A fuel cell having a composite membrane according to claim 3.

17. A fuel cell having a composite membrane according to claim 5.

18. A fuel cell having a composite membrane according to claim 8.
